(19) United States
(12) Patent Application Publication
(10) Pub. No.: US 2017/0058137 A1
(43) Pub. Date: Mar. 2, 2017

(54) AQUEOUS WRITING TOOL FOR FOOD WRAPPING MATERIAL

(71) Applicants: ASAHI KASEI HOME PRODUCTS CORPORATION, Tokyo (JP); TAISEI CORPORATION, Saitama (JP)

(72) Inventors: Mika UEKI, Tokyo (JP); Yoshiko SASAKI, Tokyo (JP); Saichi HIRAIZUMI, Saitama (JP)

(73) Assignees: ASAHI KASEI HOME PRODUCTS CORPORATION, Tokyo (JP); TAISEI CORPORATION, Saitama (JP)

(21) Appl. No.: 15/249,650

(22) Filed: Aug. 29, 2016

(30) Foreign Application Priority Data
Aug. 31, 2015 (JP) 2015-170894
Aug. 5, 2016 (JP) 2016-154431

(51) Int. Cl. C09D 11/16; C09D 11/17

(52) U.S. Cl. CPC C09D 11/16; C09D 11/17

(57) ABSTRACT

[Problem to be Solved]

An aqueous writing tool for a food product packaging material, comprising an ink with which writing can be done on food product packaging materials without being repelled can be provided.

[Solution]

An aqueous writing tool for a food product packaging material comprising an ink comprising a pigment, wherein the ink has a contact angle with a food product packaging material of 30 to 46°.

### TECHNICAL FIELD

The present invention relates to an aqueous writing tool for a food product packaging material.

### BACKGROUND ART

Ink compositions enabling writing of dates and the like on plastic bags and ultrathin transparent films for food product packaging (wrap) containing food products to be stored are known, and examples of such known ink compositions include an ink composition for a writing tool comprising at least: a water-soluble dye; an alcohol-soluble and poorly water-soluble resin contained in an amount 3 times or more the water-soluble dye in the weight ratio; and water contained in an amount twice or more and 34 times or less the water-soluble dye in the weight ratio (Patent Literature 1).

### CITATION LIST

### Patent Literature

[Patent Literature 1] Japanese Patent Application Laid-Open No. 2008-163174

### SUMMARY OF INVENTION

### Problem to be Solved by the Invention

Unfortunately, the ink described in Patent Literature 1 is a so-called oil-based ink containing more than 70% by mass alcohol (organic solvent), and has possible disadvantages of permeation of the organic solvent into food product packaging materials and contamination of food products in the packaging materials by the permeated organic solvent. In contrast, conventional water-based inks are repelled on packaging materials, and writing cannot be done thereon with such inks. Throughout the specification, the term “repelled” indicates a phenomenon which is that a water-based ink has poor wettability on hydrophobic materials, and remains on those materials in the form of liquid droplets.

The present invention has been made in consideration of these problems, and an object of the present invention is to provide an aqueous writing tool for a food product packaging material, comprising an ink with which writing can be done on food product packaging materials without being repelled.

### Solution to Problem

Namely, the present invention is as follows.

[1]

An aqueous writing tool for a food product packaging material comprising an ink comprising a pigment, wherein

the ink has a contact angle with a food product packaging material of 30 to 46°.

[2]

The aqueous writing tool for a food product packaging material according to [1], wherein

the ink further comprises inorganic particles and silicone,

the content of the inorganic particles is 0.5 to 5% by mass based on the total amount of the ink, and

the content of the silicone is 1 to 5% by mass based on the total amount of the ink.

[3]

The aqueous writing tool for a food product packaging material according to [1] or [2], wherein

the ink further comprises a moisturizing agent, and

the content of the moisturizing agent is 5% by mass or less based on the total amount of the ink.

### Effect of Invention

The present invention has been made in consideration of the above-mentioned problems, and can provide an aqueous writing tool for a food product packaging material, comprising an ink with which writing can be done on food product packaging materials without being repelled.

### DESCRIPTION OF EMBODIMENT

An embodiment according to the present invention (hereinafter, referred to as “the present embodiment”) will now be described in detail. The present invention will not be limited to the present embodiment, and various modifications can be made in the range not departing from the gist of the invention.

### [Aqueous Writing Tool for Food Product Packaging Material]

The aqueous writing tool for a food product packaging material of the present embodiment comprises an ink comprising a pigment and water, and the ink has a contact angle with a food product packaging material of 30 to 46°.

Any “food product packaging material” can be used without limitation, as long as it is generally used in the application use of food product packaging. Examples thereof include wrap films, shrink films, and food product packaging bags. Examples of resins forming these packaging materials include vinylidene chloride, vinyl chloride, polyethylene, polypropylene, poly(ethylene terephthalate), poly(propylene terephthalate), or polymers thereof. Among these, food product packaging films (wrap films) made of vinylidene chloride is preferred.

Examples of the “food product packaging material” also include containers such as air-tight containers and storage containers. Examples of a material for such containers include polyethylene, polypropylene, poly(ethylene terephthalate), poly(propylene terephthalate), polymers thereof, or glass.

The term “aqueous” indicates that the main component contained is water, the content of the water-soluble organic solvent is preferably 0 to 40% by mass, more preferably 0 to 20% by mass, still more preferably 0 to 10% by mass, particularly preferably 0 to 5% by mass based on the total amount of the ink. A smaller content of the water-soluble organic solvent tends to more significantly enhance the safety of the aqueous writing tool for a food product packaging material. The term “water-soluble” indicates that a material is miscible with water.

### [Ink]

The ink comprises a pigment, and may contain inorganic particles, silicone, poly(meth)acrylate, polyoxyalkylene alkyl ether, resin nanoparticles, a moisturizing agent, and other components when necessary. These components will now be described.

### [Contact Angle]

The contact angle of the ink with the food product packaging material is 30 to 46°, preferably 30 to 44°, and more preferably 30 to 42°. A contact angle of the ink with the food product packaging material of 30° or more can more significantly prevent smearing of the ink to portions other than places having writing. A contact angle of the ink with the food product packaging material of 46° or less more significantly enhances the wettability of the ink to the food product packaging material, so that the ink is unlikely to be repelled. The contact angle can be measured based on JIS R 3257.

### [Pigment]

Any pigments can be used without limitation. The known pigments exemplified below can be used.

Examples of the black pigment include, but not limited to, carbon black No. 2300, No. 900, MCF88, No. 33, No. 40, No. 45, No. 52, MA7, MA8, MA100, and No. 2200B (manufactured by Mitsubishi Chemical Corporation); Raven 5750, Raven 5250, Raven 5000, Raven 3500, Raven 1255, and Raven 700 (manufactured by Carbon Columbia); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (manufactured by CABOT JAPAN K.K.); and Color Black FW1, Color Black FW2, Color Black FW2 V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (manufactured by Degussa AG).

Examples of the white pigment include, but not limited to, C.I. Pigment White 6, 18, and 21, and white inorganic pigments of titanium oxide, zinc oxide, zinc sulfide, alumina, aluminum silicate, and zirconium oxide. Besides the white inorganic pigment, white organic pigments such as white hollow resin particles and polymer particles can also be used.

Examples of pigments used in yellow inks include, but not limited to, C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of magenta pigments include, but not limited to, C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, or C.I. Pigment Violet 19, 23, 32, 33, 36, 38, 43, and 50.

Examples of cyan pigments include, but not limited to, C.I. Pigment Blue 1, 2, 3, 15, 15:1, 15:2, 15:3, 15:34, 15:4, 16, 18, 22, 25, 60, 65, 66, and C.I. Vat Blue 4 and 60.

Examples of pigments other than magenta, cyan, and yellow pigments used in the color inks include, but not limited to, C.I. Pigment Green 7 and 10, C.I. Pigment Brown 3, 5, 25, and 26, C.I. Pigment Orange 1, 2, 5, 7, 13, 14, 15, 16, 24, 34, 36, 38, 40, 43, and 63.

Examples of pearl pigments include, but not limited to, pigments having pearlescence or interference gloss such as titanium dioxide, iron oxide-coated mica, argentine, and bismuth trichloride.

Examples of metallic pigments include, but not limited to, particles composed of single substances or alloys of aluminum, silver, gold, platinum, nickel, chromium, tin, zinc, indium, titanium, and copper.

The content of the pigment is preferably 7.5 to 27% by mass, more preferably 10 to 25% by mass, still more preferably 12 to 23% by mass based on the total amount of the ink. A content of the pigment of not less than 7.5% by mass tends to more significantly enhance the color developability of the resulting written products (transcript on the food product packaging material with the adhering ink). A content of the pigment of 27% by mass or less tends to more significantly enhance the dispersion stability of the ink.

### [Inorganic Particles]

The ink may further contain inorganic particles. The inorganic particles contained in the ink tend to reduce the contact angle of the ink. The inorganic particles may adhere onto the surface of the pigment to stabilize the pigment. The inorganic particles may function as a protective colloid to reduce the contact area between the pigments, thereby preventing precipitation and aggregation of the pigment. As a result, the dispersibility of the pigment can be more significantly enhanced to stably disperse a larger amount of the pigment in the ink. With these advantageous effects, a large amount of the pigment can be used, therefore the color developability of the written product obtained using the ink tends to be more significantly enhanced.

Examples of the inorganic particles include, but not limited to, silicas such as fumed silica, calcined silica, sedimented silica, pulverized silica, fused silica, fine anhydrous silica, fine hydrated silica, hydrated aluminum silicate, and hydrated calcium silicate. Among these inorganic particles, silica has a very large specific surface area, which facilitates its dispersion.

The inorganic particles have a primary average particle size of preferably 0.1 to 10 μm, more preferably 0.5 to 5 μm. A primary average particle size of the inorganic particles of 0.5 μm or more tends to more significantly enhance the dispersibility of the pigment. A primary average particle size of the inorganic particles of 5 μm or less can prevent sedimentation of silica, therefore tends to more significantly enhance the dispersion stability of the ink. The primary average particle size can be determined with an optical microscope.

The content of the inorganic particles is preferably 0.1 to 7.5% by mass, more preferably 0.5 to 5% by mass, still more preferably 0.5 to 2.5% by mass based on the total amount of the ink. A content of the inorganic particles of not less than 0.1% by mass tends to more significantly enhance the dispersibility of the pigment and tends to more significantly reduce the contact angle of the ink. A content of the inorganic particles of 7.5% by mass or less can prevent sedimentation of the inorganic particles, therefore tends to more significantly enhance the dispersion stability of the ink.

### [Silicone]

The ink may further contain silicone. The silicone contained in the ink tends to reduce the surface tension of the ink, and accompanied by this, tends to more significantly reduce the contact angle of the ink and thus prevent repellency of the ink. The silicone contained in the ink can more significantly enhance the dispersibility of the pigment to stably disperse a larger amount of the pigment in the ink. As a result, the color developability of the written product obtained using the ink tends to be more significantly enhanced. Furthermore, the silicone contained in the ink tends to enable preventing the pigment and the inorganic particles such as silica from being separated from each other and dispersed in the ink, thus more significantly preventing color separation (phenomenon which is that the hue is uneven and dappled because of uneven density).

Examples of the silicone include, but not limited to, polyether-modified silicone, polyester-modified silicone, amino-modified silicone, epoxy-modified silicone, aliphatically modified silicone, aromatically modified silicone, higher fatty acid-modified silicone, fluorine-modified silicone, carboxy-modified silicone, polyglycerol-modified silicone, epoxy polyether-modified silicone, and alkyl polyether-modified silicone. Among these silicones, polyether-modified silicone is preferred. Use of such a silicone tends to more significantly enhance the dispersibility of the pigment and reduce the contact angle of the ink. The “polyether-modified silicone” indicates silicone having a polyether group. Other modified silicones are also defined similarly.

The content of the silicone is preferably 0.5 to 7.5% by mass, more preferably 1 to 5% by mass, still more preferably 1.5 to 3% by mass based on the total amount of the ink. A content of the silicone of not less than 0.5% by mass tends to more significantly reduce the contact angle of the ink. A content of the silicone of 7.5% by mass or less tends to prevent an excess reduction in the contact angle of the ink.

### Poly(meth)acrylate

The ink may further contain poly(meth)acrylate. The poly(meth)acrylate contained in the ink more significantly tends to enhance the wettability of the pigment with the ink and thus enhance the dispersibility of the pigment in the ink. Accompanied by this, a larger amount of the pigment can be stably dispersed in the ink. As a result, the color developability of the written product obtained using the ink tends to be more significantly enhanced. Furthermore, the poly(meth)acrylate tends to be able to prevent the pigment and the inorganic particles such as silica from being separately dispersed from each other in the ink, thus more significantly preventing color separation.

Examples of the poly(meth)acrylate include, but not limited to, salt with alkali metals such as sodium; alkaline earth metals such as calcium; and ammonia and amines such as ethylamine, diethylamine, triethylamine, and propylamine.

The content of the poly(meth)acrylate is preferably 0.1 to 2% by mass, more preferably 0.25 to 1.25% by mass, still more preferably 0.45 to 0.9% by mass based on the total amount of the ink. A content of the poly(meth)acrylate of not less than 0.1% by mass tends to more significantly enhance the dispersibility of the pigment. A content of the poly(meth)acrylate of 2% by mass or less tends to reduce drying properties of the writing surfaces and also tends to prevent increase in viscosity of the ink.

### [Polyoxyalkylene Compound]

The ink may further contain a polyoxyalkylene compound. The polyoxyalkylene compound contained in the ink tends to prevent the pigment and the inorganic particles such as silica from being separately dispersed from each other in the ink, and prevent color separation. Examples of the polyoxyalkylene compound include, but not limited to, polyoxyalkylene alkyl ethers, polyoxyethylene alkylphenyl ethers, polyoxyethylene alkyl esters, polyoxyethylenealkylamides, and glycerol alkyl esters. Among these compounds, polyoxyalkylene alkyl ether is preferred.

The content of the polyoxyalkylene compound is preferably 0.05 to 1% by mass, more preferably 0.1 to 0.5% by mass, still more preferably 0.15 to 0.25% by mass based on the total amount of the ink. A content of the polyoxyalkylene compound of not less than 0.05% by mass more significantly tends to enhance the dispersibility of the pigment. A content of the polyoxyalkylene compound of 1% by mass or less tends to more significantly prevent a reduction in fixing properties and also prevent a reduction in drying properties, of writing surfaces.

### [Resin Nanoparticles]

The ink may further contain resin nanoparticles. Examples of resins for the resin nanoparticles include, but not limited to, acrylic resins, fluorinated resins, polystyrene resins, polyester resins, vinyl chloride resins, vinyl acetate resins, vinyl chloride vinyl acetate copolymerized resins, urethane resins, acrylamide resins, epoxy resins, and copolymerized resins thereof. Among these resins, acrylic resin nanoparticles and fluorinated resin nanoparticles are preferred. These resins can be used singly or in combination. The “resin nanoparticles” include resins dispersed in the ink such as emulsions and dispersions of wax particles.

Examples of the acrylic resin nanoparticles include, but not limited to, polymerized products of (meth)acrylic monomers such as (meth)acrylic acid and (meth)acrylate ester; and copolymerized products of (meth)acrylic monomers and other monomers such as styrene.

Examples of the fluorinated resin nanoparticles include, but not limited to, polytetrafluoroethylene, perfluoroalkoxyalkane, perfluoroethylenepropene copolymers, ethylene-tetrafluoroethylene copolymers, poly(vinylidene fluoride), polychlorotrifluoroethylene, ethylene-chlorotrifluoroethylene copolymers, tetrafluoroethylene-perfluorodioxole copolymers, and polyvinyl fluoride. Use of fluorinated resin particles having relatively high water repellency and low specific gravity tends to more significantly enhance the dispersion stability of the pigment and the abrasion resistance of the resulting written product.

The resin nanoparticles have a primary average particle size of preferably 0.1 to 10 μm, more preferably 0.5 to 5 μm. A primary average particle size of the resin nanoparticles within this range tends to more significantly enhance the dispersion stability of the ink. The primary average particle size can be determined with an optical microscope.

The content (solid content) of the acrylic resin nanoparticles is preferably 5 to 17.5% by mass, more preferably 7.5 to 15% by mass, still more preferably 9 to 12% by mass based on the total amount of the ink. A content of the acrylic resin nanoparticles of not less than 5% by mass tends to more significantly enhance the fixing properties of the drawn lines to objects. A content of the acrylic resin nanoparticles of 17.5% by mass or less can prevent an increase in viscosity of the ink, and tends to more significantly enhance the dispersibility of the ink. In an embodiment in which the acrylic resin nanoparticles are dispersed in a solution, the content indicates the solid content of the acrylic resin nanoparticles (the same is true below).

The content (solid content) of the fluorinated resin nanoparticles is preferably 0.1 to 5% by mass, more preferably 0.5 to 2% by mass, still more preferably 0.75 to 1.25% by mass based on the total amount of the ink. A content of the fluorinated resin nanoparticles of not less than 0.1% by mass tends to more significantly enhance the fixing properties of the drawn lines to objects and also tends to more significantly enhance the moisture resistance of the drawn lines. A content of the fluorinated resin nanoparticles of 5% by mass or less can prevent an increase in viscosity of the ink, and tends to more significantly enhance the dispersibility of the ink.

### [Moisturizing Agent]

The ink may further contain a moisturizing agent. Examples of the moisturizing agent include, but not limited to, those usually used in the ink. Examples of the moisturizing agent include organic solvents having boiling points of preferably 140° C. or more, more preferably 160° C. or more, still more preferably 180° C. or more. A moisturizing agent having a boiling point within this range tends to be less volatile, and tends to have a high moisturizing effect. Specific examples of such a moisturizing agent include, but not limited to, ethylene glycol, propylene glycol, diethylene glycol, triethylene glycol, pentamethylene glycol, trimethylene glycol, 2-butene-1,4-diol, 2-ethyl-1,3-hexanediol, 2-methyl-2,4-pentanediol, tripropylene glycol, polyethylene glycol, 1,3-propylene glycol, isopropylene glycol, isobutylene glycol, glycerol, mesoerythritol, and pentaerythritol.

The content of the moisturizing agent is preferably 0 to 5% by mass, more preferably 0 to 2.5% by mass, still more preferably 0 to 1% by mass based on the total amount of the ink. The moisturizing agent tends to prevent drying of the ink in the tips of pens and the like while reducing the drying properties of the ink written on the food product packaging materials, prolonging stickiness of the written product for a relatively long time, and reducing the moisture resistance of the written product. For these reasons, a content of the moisturizing agent of 5% by mass or less tends to more significantly enhance the drying properties and the moisture resistance of the written product and prevent the stickiness thereof. A content of the moisturizing agent of not less than 0% by mass can prevent drying of the ink in the tips of the pens and the like.

### [Other Components]

The ink may further contain a variety of additives such as a preservative agent, other dispersants, and a pH adjuster when necessary.

### [Structure of Writing Tool]

The aqueous writing tool for a food product packaging material of the present embodiment can be suitably used as writing tools such as writing tools with ink reservoir, writing tools without ink reservoir (also referred to as “direct ink feed type” writing tools), and stamps.

More specifically, the “writing tool with ink reservoir” indicates a writing tool including an ink holder accommodating a bundle of fibers (ink reservoir) and a tip of a pen (tip) from which the ink stored in the ink reservoir flows, in which the tip of the pen includes a ball, a bundle of fibers, a plastic tip, a brush-shaped nib, a sintered product, or an ink brush-shaped product. The “writing tool without ink reservoir” indicates a writing tool having no ink reservoir, including an ink holder storing an ink as it is, and a tip of a pen from which the ink stored in the ink storing portion flows, in which the tip of the pen includes a ball, a bundle of fibers, a plastic tip, a brush-shaped nib, a sintered product, or an ink brush-shaped product. Furthermore, the “stamp” indicates a writing tool that performs writing by pressing a substrate filled with an ink against an object of writing to bleed the ink from the substrate.

Among these writing tools, the aqueous writing tool for a food product packaging material of the present embodiment is preferably an writing tool with ink reservoir. A configuration of the writing tool with ink reservoir can stabilize writing in any direction of the writing tool such as a horizontal or upward direction.

### Examples

The present invention will now be more specifically described by way of Examples and Comparative Examples. The present invention will not be limited to the following Examples.

### Examples and Comparative Examples

Components were mixed according to each of the compositions shown in Tables 1 and 2 below to prepare pigment dispersion liquids Y and W. Components were mixed with the resulting pigment dispersion liquids Y and W according to each of the compositions shown in Table 3 to prepare ink compositions. The resulting inks were each charged into an ink reservoir of a writing tool with ink reservoir to prepare aqueous writing tools for a food product packaging material.

TABLE 1

| | Components | Parts by mass |
|---|---|---|
| Pigment | C.I. PIGMENT Yellow 55 | 33 |
| dispersion | Aluminum silicate | 6 |
| liquid Y | Acrylic resin^{*1} | 6 |
| | Isopropyl alcohol | 2 |
| | Water | 53 |

^{*1}manufactured by BASF Japan Ltd., product name: Joncryl J-450

TABLE 2

| | Components | Parts by mass |
|---|---|---|
| Pigment | Titanium dioxide | 55 |
| dispersion | Ethylene glycol | 10 |
| liquid W | Dispersant^{*2} | 1 |
| | Water | 34 |

^{*2}manufactured by Nikko Chemicals Co., Ltd., product name: NIKKOL BL-21

### [Contact Angle]

The contact angle was measured based on JIS R 3257. Specifically, 2 μL of the ink prepared was dropped onto a packaging material, and the angle of the liquid droplet was measured with a contact angle meter (manufactured by Kyowa Interface Science Co., Ltd., Drop Master DM-501).

### [Repellency]

A product name Saran Wrap (registered trademark) (manufactured by Asahi Kasei Home Products Corporation, made of vinylidene chloride) was provided as a food product packaging material. A region of 25 cm² squares in arbitrary place of the sample was filled with the aqueous writing tool for a food product packaging material. The region of 25 cm² squares was carefully filled such that the ink was not applied on the portions on which the tip of the pen already had run, and the amount of the ink applied onto the region of 25 cm² squares was not varied between samples. The ink applied onto the sample was visually observed to evaluate the repellency according to the following criteria:

◯: a uniform coating was formed on the entire solid region.

Δ: the repelled ink was found more than 0 area % and 30 area % or less of the solid region.

X: the repelled ink was found more than 30 area % and 100 area % or less of the solid region.

TABLE 3

| | | Example | | | | | | | Comparative Example | | |
|---|---|---|---|---|---|---|---|---|---|---|---|
| | | 1 | 2 | 3 | 4 | 5 | 6 | 7 | 1 | 2 | 3 |
| Pigment | wt % | 20 | 20 | 20 | 20 | 20 | 20 | 20 | 20 | 20 | 20 |
| dispersion liquid | | | | | | | | | | | |
| Y | | | | | | | | | | | |
| Pigment | wt % | 20 | 20 | 20 | 20 | 20 | 20 | 20 | 20 | 20 | 20 |
| dispersion liquid | | | | | | | | | | | |
| W | | | | | | | | | | | |
| Silica | wt % | 1 | 5 | 1 | 1 | 0 | 7 | 1 | 0 | 0 | 1 |
| Silicone | wt % | 2 | 2 | 3 | 2 | 2 | 2 | 7 | 0 | 0 | 0 |
| Acrylic resin | wt % | 25 | 25 | 25 | 25 | 25 | 25 | 25 | 25 | 25 | 25 |
| nanoparticles | | | | | | | | | | | |
| (solid content) | | | | | | | | | | | |
| Fluorinated resin | wt % | 1 | 1 | 1 | 1 | 1 | 1 | 1 | 1 | 1 | 1 |
| particles (solid | | | | | | | | | | | |
| content) | | | | | | | | | | | |
| Polyoxyalkylene | wt % | 0.2 | 0.2 | 0.2 | 0.2 | 0.2 | 0.2 | 0.2 | 0.2 | 0.2 | 0.2 |
| alkyl ether | | | | | | | | | | | |
| Poly(meth)acrylate | wt % | 1 | 1 | 1 | 1 | 1 | 1 | 1 | 1 | 1 | 1 |
| Preservative agent | wt % | 0.2 | 0.2 | 0.2 | 0.2 | 0.2 | 0.2 | 0.2 | 0.2 | 0.2 | 0.2 |
| Moisturizing agent | wt % | 0 | 0 | 0 | 3 | 0 | 0 | 0 | 0 | 3 | 0 |
| Water | wt % | Balance | Balance | Balance | Balance | Balance | Balance | Balance | Balance | Balance | Balance |
| Contact angle | ° | 41.0 | 35.0 | 35.0 | 42.0 | <42 | <35 | <35 | 50.0 | >42 | >42 |

| | | | | | | | | | | |
|---|---|---|---|---|---|---|---|---|---|---|
| Repellency | ◯ | ◯ | ◯ | ◯ | ◯ | Δ | ◯ | X | X | X |

### [Silica]

Sunsphere H-31 manufactured by AGC Si-Tech. Co., Ltd.

### [Silicone]

KF6011 (polyether-modified silicone), manufactured by Shin-Etsu Chemical Co., Ltd.,

### [Resin Nanoparticles]

NEOCRYL A-1120 (acrylic resin nanoparticles), manufactured by Kusumoto Chemicals, Ltd.

KTL-1N (fluorinated resin nanoparticles), manufactured by KITAMURA LIMITED

### Polyoxyalkylene alkyl ether

product name NIKKOL BL-21 (polyoxyethylene alkyl ether) manufactured by Nikko Chemicals Co., Ltd.

### Poly(meth)acrylate

Aqualic L-DL (sodium polyacrylate), manufactured by NIPPON SHOKUBAI CO., LTD.

### [Preservative Agent]

New Side S-01 (sodium dehydroacetate), manufactured by The Nippon Synthetic Chemical Industry Co., Ltd.

### [Moisturizing Agent]

product name: ethylene glycol (compound name: ethylene glycol), manufactured by Mitsubishi Chemical Corporation

### INDUSTRIAL APPLICABILITY

The aqueous writing tool for a food product packaging material of the present embodiment has industrial applicability as a writing tool comprising a water-based ink with which writing can be readily done on food product packaging materials without being repelled by the food product packaging materials.

1. An aqueous writing tool for a food product packaging material comprising an ink comprising a pigment, wherein
the ink has a contact angle with a food product packaging material of 30 to 46°.

2. The aqueous writing tool for a food product packaging material according to claim 1, wherein
the ink further comprises inorganic particles and silicone,
the content of the inorganic particles is 0.5 to 5% by mass based on the total amount of the ink, and
the content of the silicone is 1 to 5% by mass based on the total amount of the ink.

3. The aqueous writing tool for a food product packaging material according to claim 1 or 2, wherein
the ink further comprises a moisturizing agent, and
the content of the moisturizing agent is 5% by mass or less based on the total amount of the ink.
